(19) United States
(12) Patent Application Publication
(10) Pub. No.: US 2013/0218928 A1
(43) Pub. Date: Aug. 22, 2013

(54) INFORMATION PROCESSING DEVICE

(71) Applicants: Tsunehisa Kawamata, Tokyo (JP); Takeshi Arikuma, Tokyo (JP)

(72) Inventors: Tsunehisa Kawamata, Tokyo (JP); Takeshi Arikuma, Tokyo (JP)

(73) Assignee: NEC CORPORATION, Minato-ku, Tokyo (JP)

(21) Appl. No.: 13/824,194

(22) PCT Filed: Nov. 7, 2011
(86) PCT No.: PCT/JP2011/006187

§ 371 Date: May 14, 2013

(30) Foreign Application Priority Data
Nov. 9, 2010 (JP) 2010-250629

(51) Int. Cl. G06F 17/30

(52) U.S. Cl. CPC G06F 17/30958
USPC 707/798

(57) ABSTRACT

An information processing device is connected to a database storing graph data having been generated by analysis engines and having a data structure that plural nodes are connected, and includes: a node information database which is set for each of the graph data compatible with the respective analysis engines and in which, with path information referring to a node in the graph data, identification information that is information for identifying the node and that is identical for identical nodes is associated; and a data processing means for, based on the node information database, executing a process of associating a node in the graph data having a predetermined data structure generated by a predetermined analysis engine and a node in the graph data generated by another analysis engine associated with identical identification information to the identification information associated with the node in the graph data having the predetermined data structure.

### TECHNICAL FIELD

The present invention relates to an information processing device, more specifically, relates to an information processing device supporting data management in a system in which a plurality of databases exist.

### BACKGROUND ART

In recent years, as an information processing technique has developed, an analysis engine analyzing various types of data has been developed. There are various types of analysis engines, for example, generating location information for tracing the flow of a person from moving image data, specifying a person from still image data, generating text data from speech data, and so on.

An analysis engine is improved all the time for the purpose of increase of the accuracy and speed of analysis. Accordingly, in an improved analysis engine, there is a case that the structure of data accumulated in a database is changed or data is added. In this case, when the old structure of data and the new structure of data are compatible with each other, it is possible to access the respective data from both old and new applications used for accessing the database.

### PATENT DOCUMENTS

Patent Document 1: Japanese Unexamined Patent Application Publication No. 2007-257083

However, when the structures of the data as the results of analysis by the old and new analysis engines are different from each other, there arises a problem that it may be impossible to access data generated by the new analysis engine from the old application compatible with the old analysis engine. Moreover, for accessing data analyzed by the old analysis engine from the new application, there is a need to incorporate a rule of conversion of a data structure so as to enable access to the old data structure into the new application. In this case, however, an application developer needs to understand the rule of conversion of a data structure, and there arises a problem that, as the number of applications increases, it takes much more effort and cost to develop the applications.

As a related technique, there is a system disclosed by Patent Document 1. This Patent Document 1 discloses a method of integrating necessary data from a plurality of databases and providing a logical view. According to the technique disclosed by Patent Document 1, however, an old version of view generation rule on the application needs to be changed every time a database is added or changed, and there arises a problem that it takes much effort and cost for a system manager.

### SUMMARY

Accordingly, an object of the present invention is to solve the abovementioned problems: it takes effort and cost to manage and develop in a system in which databases having different data structures exist.

In order to achieve the object, an information processing device according to an exemplary embodiment of the present invention is connected to a database storing graph data that are analysis results generated by analysis engines, respectively, and that have a data structure in which a plurality of nodes are connected.

The information processing device includes:

a node information database which is set for each of the graph data compatible with the respective analysis engines and in which, with path information referring to a node in the respective graph data, identification information that is information for identifying the node referred to by the path information and that is identical for identical nodes is associated; and

a data processing means for, based on the node information database, executing a process of associating a node in the graph data having a predetermined data structure generated by a predetermined analysis engine and a node in the graph data generated by another analysis engine associated with identical identification information to the identification information associated with the node in the graph data having the predetermined data structure.

Further, a computer program according to another exemplary embodiment of the present invention is a computer program including instructions for causing an information processing device connected to a database storing graph data that are analysis results generated by analysis engines, respectively, and that have a data structure in which a plurality of nodes are connected, to realize:

a data processing means for, based on a node information database which is set for each of the graph data compatible with the respective analysis engines and in which, with path information referring to a node in the respective graph data, identification information that is information for identifying the node referred to by the path information and that is identical for identical nodes is associated, executing a process of associating a node in the graph data having a predetermined data structure generated by a predetermined analysis engine and a node in the graph data generated by another analysis engine associated with identical identification information to the identification information associated with the node in the graph data having the predetermined data structure.

Further, an information processing method according to another exemplary embodiment of the present invention includes:

by an information processing device connected to a database storing graph data that are analysis results generated by analysis engines, respectively, and that have a data structure in which a plurality of nodes are connected,

based on a node information database which is set for each of the graph data compatible with the respective analysis engines and in which, with path information referring to a node in the respective graph data, identification information that is information for identifying the node referred to by the path information and that is identical for identical nodes is associated, executing a process of associating a node in the graph data having a predetermined data structure generated by a predetermined analysis engine and a node in the graph data generated by another analysis engine associated with identical identification information to the identification information associated with the node in the graph data having the predetermined data structure.

With the configurations and functions as described above, the present invention can realize data management and system development in a system in which databases having different data structures exist.

### BRIEF DESCRIPTION OF DRAWINGS

FIG. 1 is a block diagram showing a configuration of an information processing system in a first exemplary embodiment of the present invention;

FIG. 2 is a diagram showing an example of a graph structure definition DB disclosed in FIG. 1;

FIG. 3 is a diagram showing an example of graph data conversion in the information processing system disclosed in FIG. 1;

FIG. 4 is a diagram showing an example of storage after graph data conversion in the information processing system disclosed in FIG. 1;

FIG. 5 is a diagram showing an example of graph data conversion in the information processing system disclosed in FIG. 1;

FIG. 6 is a diagram showing an example of storage after graph data conversion in the information processing system disclosed in FIG. 1;

FIG. 7 is a diagram showing an example of generation of a graph search expression in the information processing system disclosed in FIG. 1;

FIG. 8 is a diagram showing an example of generation of a graph search expression in the information processing system disclosed in FIG. 1; and

FIG. 9 is a block diagram showing a configuration of an information processing device according to Supplementary Note 1 of the present invention.

### EXEMPLARY EMBODIMENTS

### First Exemplary Embodiment

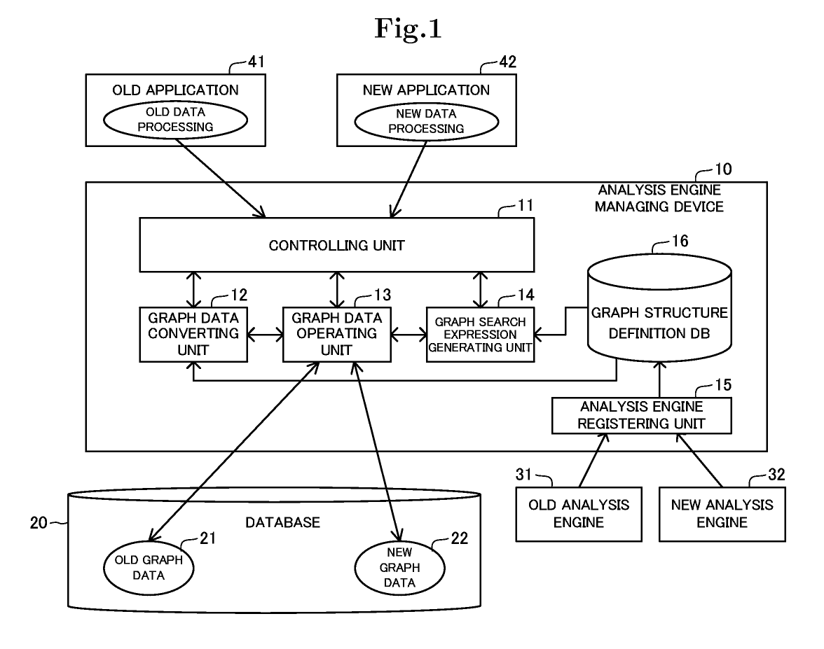

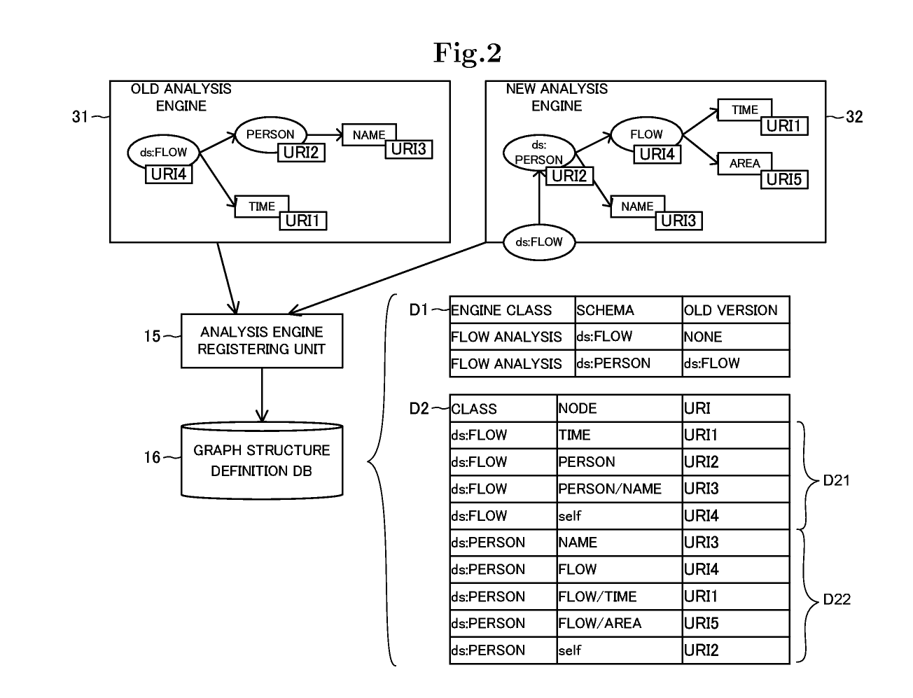

A first exemplary embodiment of the present invention will be described with reference to FIGS. 1 to 8. FIG. 1 is a diagram showing a configuration of the present invention, and FIGS. 2 to 8 are explanation diagrams for explaining an operation.

As shown in FIG. 1, an information processing system in the present invention is a system which includes a plurality of analysis engines 31 and 32, accumulates the results of analysis by the respective analysis engines into a database 20, and outputs the results. To be specific, in this exemplary embodiment, the information processing system includes the old version of analysis engine 31 and new version of analysis engine 32 that analyze the same type of data but outputs graph data having different data structures as analysis results. Moreover, the information processing system correspondingly includes an old application 41 for accessing old graph data 21 as the result of analysis by the old version of analysis engine 31 and executing the process, and a new application 42 for accessing new graph data 22 as the result of analysis by the new version of analysis engine 32 and executing the process.

Further, in this exemplary embodiment, the information processing system includes an analysis engine managing device 10 for making it possible to access both the old graph data 21 and the new graph data 22 stored in the database 20 and execute the process from both the old application 41 and the new application 42.

As shown in FIG. 1, the analysis engine managing device 10 (an information processing device) includes a controlling unit 11, a graph data converting unit 12, a graph data operating unit 13, a graph search expression generating unit 14 and an analysis engine registering unit 15, which are constructed by installing programs into an included arithmetic device. Moreover, the analysis engine managing device 10 includes a graph structure definition DB (database) 16 formed in an included storage device.

The controlling unit 11 is configured to control an operation of the analysis engine managing unit 10. For example, the controlling unit 11 accepts process requests from the applications 41 and 42, issuing process instructions to the graph data converting unit 12, the graph data operating unit 13 and the graph search expression generating unit 14, respectively, and executes a process of returning the results of the processes by the units to the applications 41 and 42.

The analysis engine registering unit 15 has a function of registering information representing the data structures of the graph data as the results of analysis by the analysis engines 31 and 32 into the graph structure definition DB 16 (a node information database). The analysis engine registering unit 15 may register information representing the data structures of graph data compatible with the respective analysis engines 31 and 32 having been manually inputted by an operator, into the graph structure definition DB 16, or may accept input of information representing the data structures of graph data outputted by the analysis engines and register into the graph structure definition DB 16.

An example of the information registered by the analysis engine registering unit 15 into the graph structure definition DB 16 will be described with reference to FIG. 2. At first, the data structures of the graph data as the results of analysis by the analysis engines 31 and 32 will be described. The analysis engines 31 and 32 in this exemplary embodiment are analysis engines each generating location information for tracing the flow of a person from moving image data, which are the analysis engines 31 and 32 analyzing almost the same contents, respectively, but outputting old and new versions of graph data having different data structures as the analysis results.

For example, the graph data 21 generated by the old version of analysis engine 31 is configured as shown within the old analysis engine 31 of FIG. 2 in a manner that “flow” located at the top, “person” and “time” located therebelow and “name” located below “person” are linked as nodes configuring the graph data. Moreover, the graph data 22 generated by the new version of analysis engine 32 is configured as shown within the new analysis engine 32 of FIG. 2 in a manner that “person” located at the top instead of “flow” of the old version, “name” and “flow” located therebelow, and “time” and “area” located below “flow” are linked as nodes configuring the graph data. “Area” is a node additionally included in the new version of analysis engine 32.

The data structures of the respective data described above are registered into the graph structure definition DB 16 by the analysis engine registering unit 15 as shown by “engine definition data” denoted by reference symbol D1 and “node URI mapping data” denoted by reference symbol D2 in FIG. 2.

The “engine definition data” D1 stores “engine class” unique depending on the type of an analysis engine, “schema” for identifying the data structure of graph data, and “old version” representing the data structure of the old version of the analysis engine. Herein, because both the analysis engines are of the same type, namely, the type of performing flow analysis, “flow analysis” is stored in “engine class” of each of the engines. Further, “ds: flow” is stored in “schema” of the old analysis engine 31, and “ds: person” is stored in “schema” of the new analysis engine 32. Furthermore, nothing is stored in “old version” of the old analysis engine 31, and “ds: flow” is stored in “old version” of the new analysis engine 32.

The “node URI mapping data” D2 stores “class” for identifying the data structure of each of the analysis engines, “node” as path information for referring to each of the nodes within the graph data of the analysis engines, and “URI” as identification information for identifying each of the nodes.

To be specific, in a portion (D21) of four lines from the top in the “node URI mapping data” D2 shown in FIG. 2, information of the graph data of the old analysis engine 31 is stored. That is to say, information “ds: flow” is stored in all fields of “class,” and path information for the respective nodes are stored in fields of “node.” For example, because a node “flow” is located at the top in the graph data, information “self” is stored therein. Because a node “name” is located in a hierarchy “flow”→“person”→“name” within the graph data, information “person/name” is stored therein.

In a field of “URI,” “URI” unique to each “node” is stored in association with the node. For example, a URI “URI 1” is stored in association with a node “time,” a URI “URI 2” is stored in association with a node “person,” a URI “URI 3” is stored in association with a node “name,” and a URI “URI 4” is stored in association with a node “flow.”

Further, in a portion (D22) of five lines from the bottom in the “node URI mapping data” D2 shown in FIG. 2, information of the graph data of the new analysis engine 32 is stored. That is to say, information “ds: person” is stored in all fields of “class,” and path information for the respective nodes are stored in fields of “node.” For example, because a node “person” is located at the top within the graph data, information “self” is stored therein. Because a node “time” is located in a hierarchy “person”→“flow”→“time” within the graph data, information “flow/time” is stored therein.

In a field of “URI,” a “URI” unique to each “node” is stored in association with the node, and the same URI is stored in association with the same node as the node within the graph data of the old analysis engine 31. For example, the URI “URI 3” is stored in association with the node “name,” the URI “URI 4” is store in association with the node “flow,” the URI “URI 1” is stored in association with the node “time,” and the URI “URI 2” is stored in association with the node “person.” However, because the node “area” is a node which is not included in the graph data of the old analysis engine 31, new “URI 5” is associated as a URI thereof.

Then, the graph data converting unit 12 converts the graph data by using the information within the graph structure definition DB 16 described above. When actually accessing the graph data 21 and 22 within the database 20 as described later, the graph data converting unit 12 accesses the data via the graph data operating unit 13, but it is assumed in the following description that the graph data converting unit 12 thus functions.

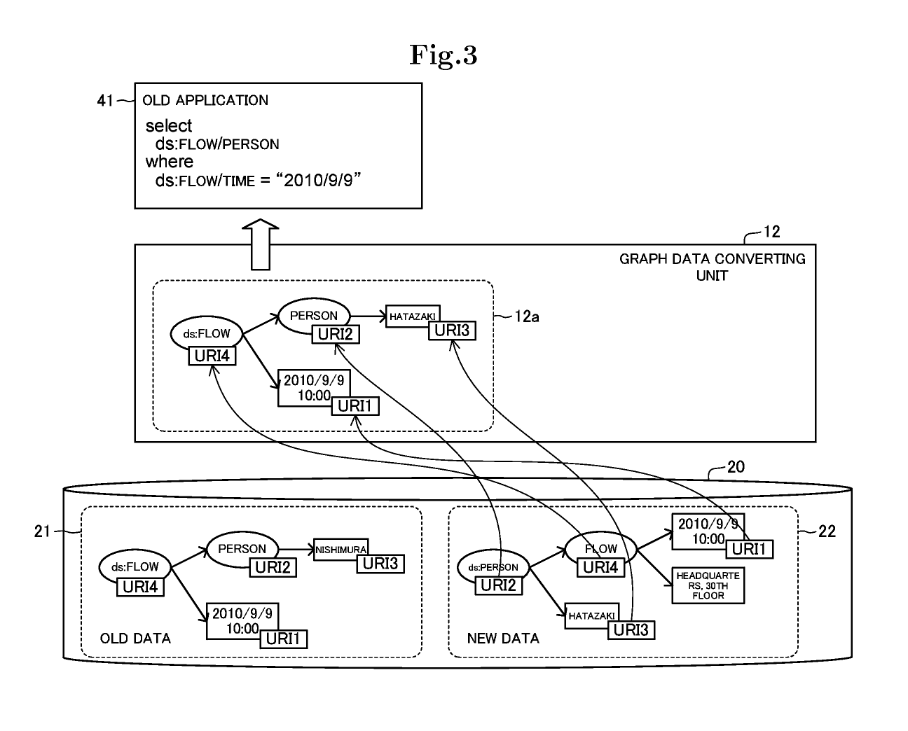

With reference to FIG. 3, an aspect of accessing the new graph data 22 generated by the new analysis engine 32 and stored into the database 20 from the old application 41 compatible with the old analysis engine 31 will be described. The example of FIG. 3 shows a case that information of “person” with “time” of “2010/9/9 10:00” stored as the new graph data is retrieved by the old application 41.

In response to a request by the old application 41, the graph data converting unit 12 accesses the nodes of the new graph data 22 with reference to “path information” in the graph structure definition DB 16. In this case, specifically, the graph data converting unit 12 accesses the node “time” and the nodes “person” and “name” in the new graph data 22. At this moment, the graph data converting unit 12 also refers to “URI” of each of the accessed nodes. Thus, the graph data converting unit 12 can specify “URI 1” as the “URI” of the node “time,” and can specify “URI 2” and “URI 3” as “URI” of the nodes “person” and “name.” The graph data converting unit 12 then retrieves the information of each of the accessed nodes of the new graph data 22 by associating with a location of “path information” of a node of the old graph data 21 associated with the same “URI” as “URI” of the each node.

Consequently, as shown by reference numeral 12a in FIG. 3, it is possible to convert the new graph data 22 into the data structure of the old graph data 21, and output the graph data 12a from the old application 41. In the above example, it is possible to respond to a request by the old application 41, by limiting to the new graph data 22 with “time” of “2010/9/9 10:00.”

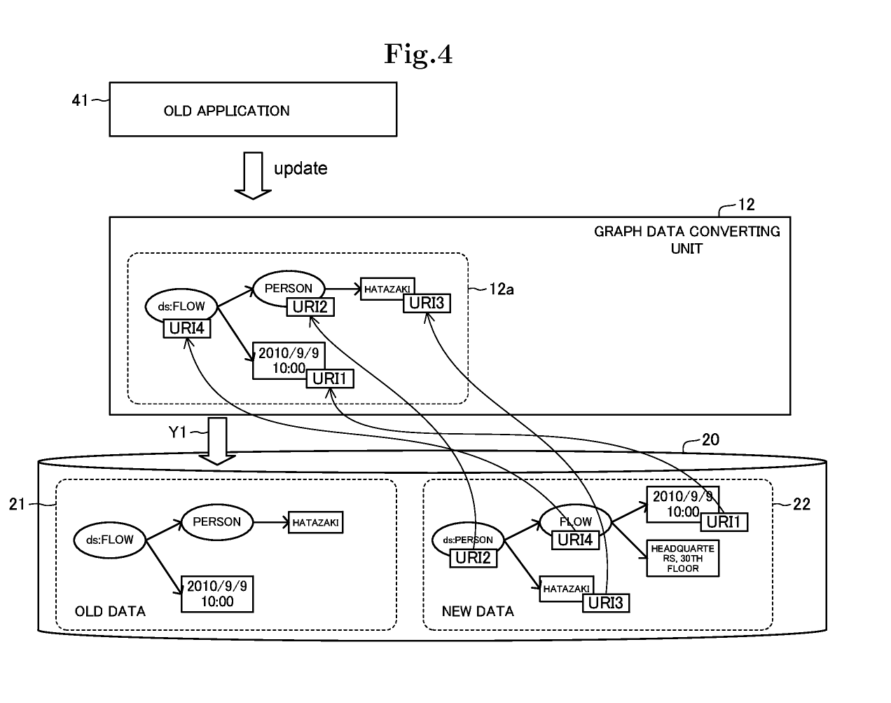

In response to a request for update by the old application, the graph data converting unit 12 can store the old graph data 12a converted from the new graph data 22 shown in FIG. 3 as it is into the database 20 as the old graph data 21 as shown by arrow Y1 in FIG. 4.

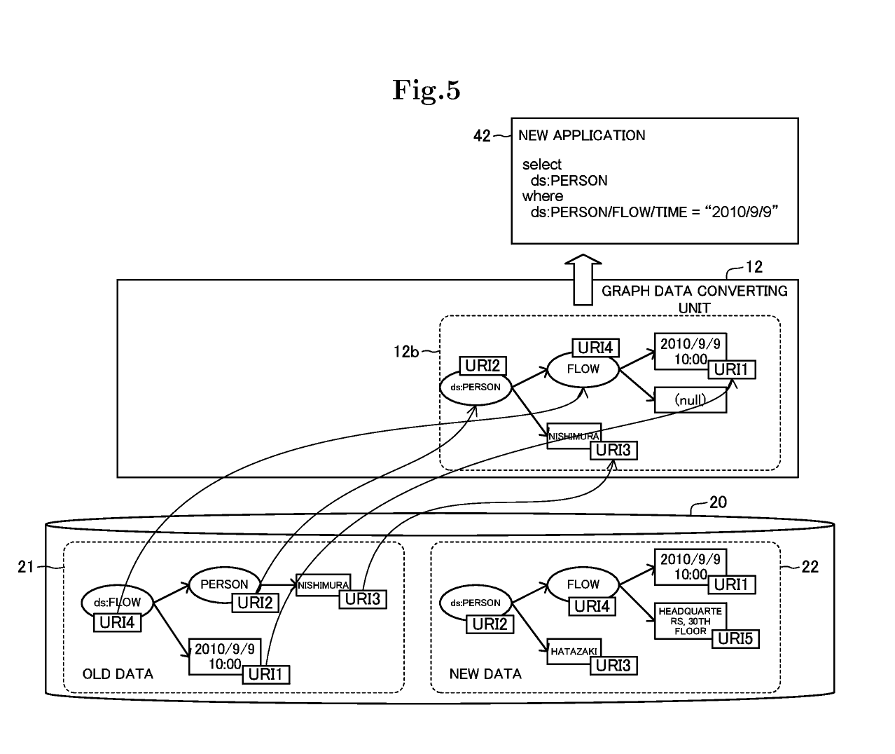

Next, with reference to FIG. 5, an aspect of accessing the old graph data 21 generated by the old analysis engine 31 and stored into the database 20 from the new application 42 compatible with the new analysis engine 32 will be described. The example of FIG. 5 shows a case that information of “person” with “time” of “2010/9/9 10:00” stored as the old graph data is retrieved by the new application 42.

In response to a request by the new application 42, the graph data converting unit 12 accesses the nodes of the old graph data 21 with reference to “path information” within the graph structure definition DB 16. In this case, specifically, the graph data converting unit 12 accesses the node “time” and the nodes “person” and “name” in the old graph data 21. At this moment, the graph data converting unit 12 also refers to “URI” of each of the accessed nodes. Thus, the graph data converting unit 12 can specify “URI 1” as the “URI” of the node “time,” and can specify “URI 2” and “URI 3” as “URI” of the nodes “person” and “name.” The graph data converting unit 12 then retrieves the information of each of the accessed nodes of the old graph data 21, by associating with a location of “path information” of a node of the new graph data 22 associated with the same “URI” as “URI” of the each node.

Consequently, as shown by reference numeral 12b in FIG. 5, it is possible to convert the old graph data 21 into the data structure of the new graph data 22, and output the graph data 12b from the new application. In the above example, it is possible to respond to a request by the new application 42, by limiting to the old graph data 21 with “time” of “2010/9/9 10:00.”

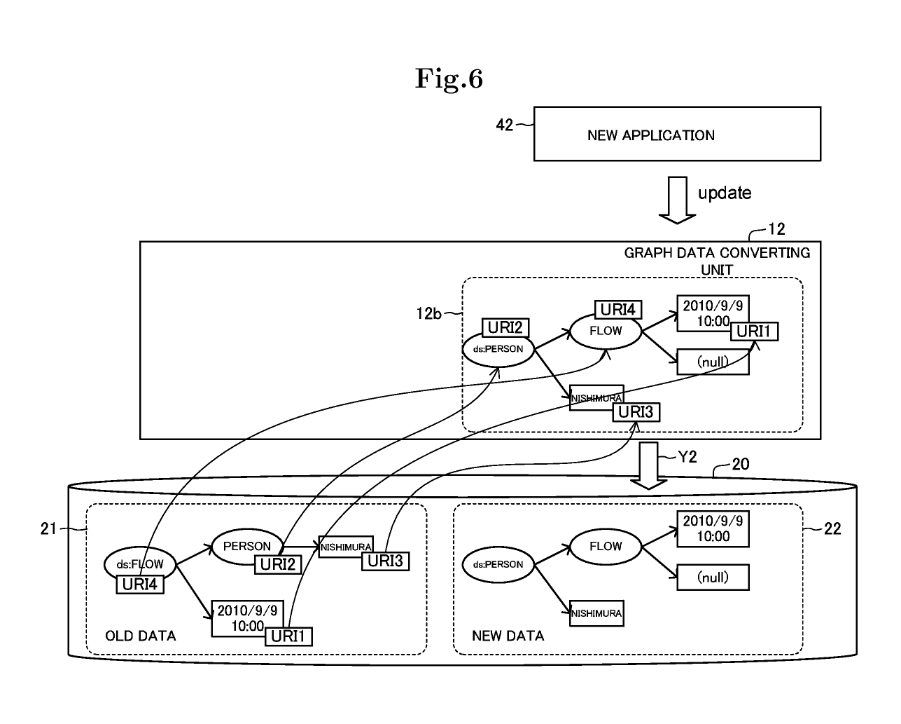

In response to a request for update by the new application, the graph data converting unit 12 can store the new graph data 12b converted from the old graph data 21 shown in FIG. 5 as it is into the database 20 as the new graph data 22 as shown by arrow Y2 in FIG. 6.

The update process of changing the data structure of the graph data described above may be executed on all of the graph data stored in the database 20 together at any timing. For example, all of the old graph data 21 stored in the database 20 may be converted into the data structure of the new graph data 22.

Next, the graph search expression generating unit 14 will be described. The graph search expression generating unit 14 searches the old graph data 21 and the new graph data 22 by using the information in the graph structure definition DB 16. When actually accessing the graph data 21 and 22 within the database 20 as described later, the graph search expression generating unit 14 accesses the data via the graph data operating unit 13 and the graph data converting unit 12, but it is assumed in the following description that the graph search expression generating unit 14 thus functions.

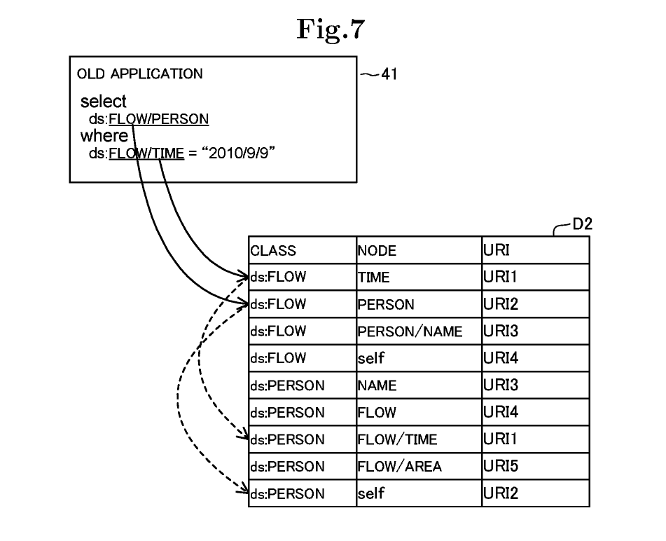

With reference to FIG. 7, an aspect of searching for graph data which satisfies a predetermined condition within all of the graph data 21 and 22 stored in the database 20 from the old application 41 compatible with the old analysis engine 31 will be described. The example of FIG. 7 shows a case of searching information of “person” with “time” of “2010/9/9 10:00” from all of the graph data 21 and 22.

In response to a request by the old application 41, firstly, the graph search expression generating unit 14 accesses the nodes within the old graph data 21 with reference to “path information” in the node URI mapping data D2 in the graph structure definition DB 16. In this case, specifically, the graph search expression generating unit 14 accesses the node “time” and the node “person” in the old graph data 21, and searches for information of “person” with time” of “2010/9/9 10:00” in the old graph data 21.

At this moment, the graph search expression generating unit 14 also refers to “URI” of each of the accessed nodes of the old graph data 21. Thus, as shown in FIG. 7, the graph search expression generating unit 14 can specify “URI 1” as the “URI” of the node “time,” and can specify “URI 2” as “URI” of the node “person.” The graph search expression generating unit 14 then specifies a URI in the new graph data 22 associated with the same URI as the specified “URI 1” and “URI 2,” as shown by dotted-line arrows in FIG. 7, and generates a search expression so that the URI in the new graph data 22 also becomes a search target.

After that, in accordance with the generated search expression, the graph search expression generating unit 14 accesses the nodes in the new graph data 22 with reference to “path information” in the graph structure definition DB 16 associated with the corresponding URI in the new graph data 22. Consequently, the graph search expression generating unit 14 can access the node “time” and the node “person” in the new graph data 22, and can search for information of “person” with “time” of “2010/9/9 10:00” in the graph data 22.

The new graph 22 having been searched may be outputted after being converted into the data structure of the old graph data 21 by the graph data converting unit 12 as described above so that it is possible to refer to from the old application 41.

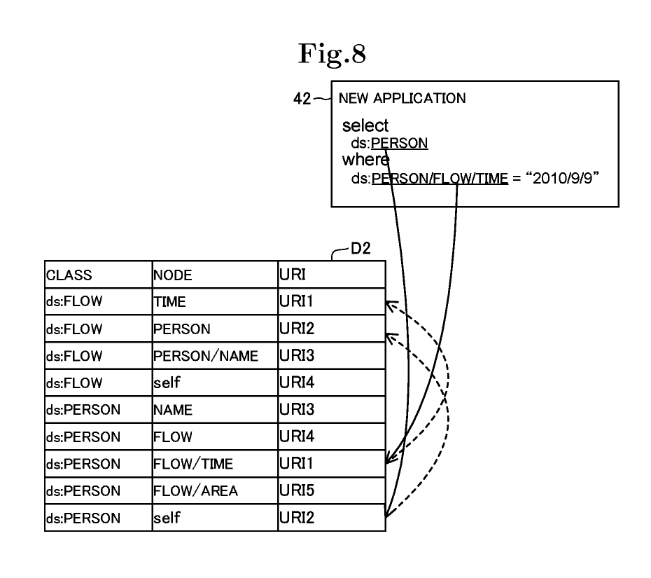

Further, with reference to FIG. 8, an aspect of searching for graph data which satisfies a predetermined condition within all of the graph data 21 and 22 stored in the database 20 from the new application 42 compatible with the new analysis engine 32 will be described. The example of FIG. 8 shows a case of searching for information of “person” with “time” of “2010/9/9 10:00” in all of the graph data 21 and 22 from the new application 42.

In response to a request by the new application 42, firstly, the graph search expression generating unit 14 accesses the nodes in the new graph data 22 with reference to “path information” in the node URI mapping data D2 in the graph structure definition DB 16. In this case, specifically, the graph search expression generating unit 14 accesses the node “time” and the node “person” in the new graph data 22, and searches for information of “person” with time” of “2010/9/9 10:00” in the new graph data 22.

At this moment, the graph search expression generating unit 14 also refers to “URI” of each of the accessed nodes of the new graph data 22. Thus, as shown by a solid-line arrow in FIG. 8, the graph search expression generating unit 14 can specify “URI 1” as the “URI” of the node “time,” and can specify “URI 2” as the “URI” of the node “person.” The graph search expression generating unit 14 then specifies a URI in the old graph data 21 associated with the same URI as the specified “URI 1” and “URI 2” as shown by dotted-line arrows in FIG. 8, and generates a search expression so that the URI in the old graph data 21 also becomes a search target.

After that, in accordance with the generated search expression, the graph search expression generating unit 14 accesses the nodes in the old graph data 21 with reference to “path information” in the graph structure definition DB 16 associated with the corresponding URI in the old graph data 21. Consequently, the graph search expression generating unit 14 can access the node “time” and the node “person” in the old graph data 21, and can search for information of “person” with “time” of “2010/9/9 10:00” in the graph data 21.

The old graph data 21 having been searched may be outputted after being converted into the data structure of the new graph data 22 by the graph data converting unit 12 as described above so that it is possible to refer to from the old application 41.

As described above, generation of a search expression between different analysis engines is performed between analysis engines whose analysis contents are the same. For example, the generation is performed between different versions of analysis engines whose analysis contents are the same as mentioned above. The generation is performed between analysis engines whose data in the “engine class” fields in the engine definition data D1 in the graph structure definition DB 16 are the same.

Further, in response to a data deletion request by either one of the applications 41 and 42, the graph data operating unit 13 deletes data of a corresponding node in all of the graph data 21 and 22 in the database 20. Herein, a case that the old application 41 or the new application 42 makes a request for deletion of data of the node “name” will be described.

First, in a case that the old application 41 makes a request for deletion of the node “name,” the graph data operating unit 13 accesses the node “name” in the old graph data 21 with reference to “path information” in the graph structure definition DB 16, and deletes data of the node “name.” At this moment, the graph data operating unit 13 refers to “URI” of the accessed node “name,” and specifies “URI 3” as the “URI” of the node “name.” Then, the graph data operating unit 13 accesses the node “name” in the new graph data 22 associated with the same “URI 3” as the specified “URI 3,” and also deletes data of the node.

Further, in a case that the new application 42 makes a request for deletion of the node “name,” the graph data operating unit 13 accesses the node “name” in the new graph data 22 with reference to “path information” in the graph structure definition DB 16, and deletes data of the node “name.” At this moment, the graph data operating unit 13 refers to “URI” of the accessed node “name,” and specifies “URI 3” as the “URI” of the node “name.” Then, the graph data operating unit 13 accesses the node “name” in the old graph data 21 associated with the same “URI 3” as the specified “URI 3,” and deletes data of the node.

Thus, according to the present invention, even when the structures of data as the results of analysis by the old and new analysis engines are different from each other, it is possible, by associating the same nodes in the respective graph data generated by the different analysis engines with the same URI and associating the nodes with each other, to access the respective graph data from the applications corresponding to the respective analysis engines. Therefore, there is no need to incorporate the rule of conversion of a data structure into the respective applications, and it is possible to limit the effort of management of the database in the whole system and the cost for development.

### SUPPLEMENTARY NOTES

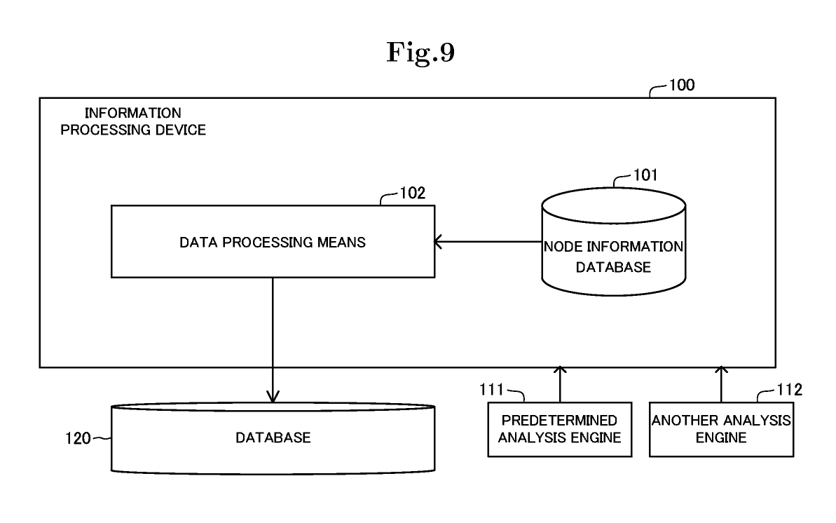

The whole or part of the exemplary embodiments disclosed above can be described as the following supplementary notes. Below, the overview of the configuration of the information processing device according to the present invention will be described with reference to FIG. 9. However, the present invention is not limited to the following configurations.

### (Supplementary Note 1)

An information processing device 100, connected to a database 120 storing graph data that are analysis results generated by analysis engines 111 and 112, respectively, and that have a data structure in which a plurality of nodes are connected,

the information processing device including:

a node information database 101 which is set for each of the graph data compatible with the respective analysis engines 111 and 112 and in which, with path information referring to a node in the respective graph data, identification information that is information for identifying the node referred to by the path information and that is identical for identical nodes is associated; and

a data processing means 102 for, based on the node information database 101, executing a process of associating a node in the graph data having a predetermined data structure generated by a predetermined analysis engine 111 and a node in the graph data generated by another analysis engine 112 associated with identical identification information to the identification information associated with the node in the graph data having the predetermined data structure.

### (Supplementary Note 2)

The information processing device according to Supplementary Note 1, wherein the data processing means is configured to apply information of a node in the graph data generated by the other analysis engine associated with a node in the graph data having the predetermined data structure generated by the predetermined analysis engine to the node in the graph data generated by the predetermined analysis engine, and convert the data structure of the graph data generated by the other analysis engine into the data structure of the graph data generated by the predetermined analysis engine.

### (Supplementary Note 3)

The information processing device according to Supplementary Note 2, wherein the data processing means is configured to store the graph data generated by the other analysis engines having been converted into the data structure of the graph data generated by the predetermined analysis engine into the database in the data structure after the conversion.

### (Supplementary Note 4)

The information processing device according to any of Supplementary Notes 1 to 3, wherein the data processing means is configured to, in response to a request to search for a predetermined node in the graph data having the predetermined data structure generated by the predetermined analysis engine, search for a node in the graph data generated by the other analysis engine associated with the predetermined node.

### (Supplementary Note 5)

The information processing device according to any of Supplementary Notes 1 to 4, wherein the data processing means is configured to, in response to a request to delete a predetermined node in the graph data having the predetermined data structure generated by the predetermined analysis engine, delete a node in the graph data generated by the other analysis engine associated with the predetermined node.

### (Supplementary Note 6)

The information processing device according to any of Supplementary Notes 1 to 5, wherein the predetermined analysis engine and the other analysis engine are analysis engines whose analysis contents are identical to each other.

### (Supplementary Note 7)

A computer program including instructions for causing an information processing device connected to a database storing graph data that are analysis results generated by analysis engines, respectively, and that have a data structure in which a plurality of nodes are connected, to realize:

a data processing means for, based on a node information database which is set for each of the graph data compatible with the respective analysis engines and in which, with path information referring to a node in the respective graph data, identification information that is information for identifying the node referred to by the path information and that is identical for identical nodes is associated, executing a process of associating a node in the graph data having a predetermined data structure generated by a predetermined analysis engine and a node in the graph data generated by another analysis engine associated with identical identification information to the identification information associated with the node in the graph data having the predetermined data structure.

### (Supplementary Note 8)

The computer program according to Supplementary Note 7, wherein the data processing means is configured to apply information of a node in the graph data generated by the other analysis engine associated with a node in the graph data having the predetermined data structure generated by the predetermined analysis engine to the node in the graph data generated by the predetermined analysis engine, and convert the data structure of the graph data generated by the other analysis engine into the data structure of the graph data generated by the predetermined analysis engine.

### (Supplementary Note 9)

An information processing method includes:

by an information processing device connected to a database storing graph data that are analysis results generated by analysis engines, respectively, and that have a data structure in which a plurality of nodes are connected,

based on a node information database which is set for each of the graph data compatible with the respective analysis engines and in which, with path information referring to a node in the respective graph data, identification information that is information for identifying the node referred to by the path information and that is identical for identical nodes is associated, executing a process of associating a node in the graph data having a predetermined data structure generated by a predetermined analysis engine and a node in the graph data generated by another analysis engine associated with identical identification information to the identification information associated with the node in the graph data having the predetermined data structure.

### (Supplementary Note 10)

The information processing method according to Supplementary Note 9, including:

by the information processing device,

applying information of a node in the graph data generated by the other analysis engine associated with a node in the graph data having the predetermined data structure generated by the predetermined analysis engine to the node in the graph data generated by the predetermined analysis engine, and converting the data structure of the graph data generated by the other analysis engine into the data structure of the graph data generated by the predetermined analysis engine.

The present invention is based upon and claims the benefit of priority from Japanese patent application No. 2010-250629, filed on Nov. 9, 2010, the disclosure of which is incorporated herein in its entirety by reference.

### DESCRIPTION OF REFERENCE NUMERALS

10 analysis engine managing device
11 controlling unit
12 graph data converting unit
13 graph data operating unit
14 graph search expression generating unit
15 analysis engine registering unit
16 graph structure definition DB
20 database
21 old graph data
22 new graph data
31 old analysis engine
32 new analysis engine
41 old application
42 new application
100 information processing device
101 node information database
102 data processing means
111 predetermined analysis engine
112 another analysis engine
120 database

What is claimed is:

1. An information processing device connected to a database storing graph data that are analysis results generated by analysis engines, respectively, and that have a data structure in which a plurality of nodes are connected,
the information processing device comprising:
a node information database which is set for each of the graph data compatible with the respective analysis engines and in which, with path information referring to a node in the respective graph data, identification information that is information for identifying the node referred to by the path information and that is identical for identical nodes is associated; and
a data processing unit for, based on the node information database, executing a process of associating a node in the graph data having a predetermined data structure generated by a predetermined analysis engine and a node in the graph data generated by another analysis engine associated with identical identification information to the identification information associated with the node in the graph data having the predetermined data structure.

2. The information processing device according to claim 1, wherein the data processing unit is configured to apply information of a node in the graph data generated by the other analysis engine associated with a node in the graph data having the predetermined data structure generated by the predetermined analysis engine to the node in the graph data generated by the predetermined analysis engine, and convert the data structure of the graph data generated by the other analysis engine into the data structure of the graph data generated by the predetermined analysis engine.

3. The information processing device according to claim 2, wherein the data processing unit is configured to store the graph data generated by the other analysis engines having been converted into the data structure of the graph data generated by the predetermined analysis engine into the database in the data structure after the conversion.

4. The information processing device according to any of claim 1, wherein the data processing unit is configured to, in response to a request to search for a predetermined node in the graph data having the predetermined data structure generated by the predetermined analysis engine, search for a node in the graph data generated by the other analysis engine associated with the predetermined node.

5. The information processing device according to claim 1, wherein the data processing unit is configured to, in response to a request to delete a predetermined node in the graph data having the predetermined data structure generated by the predetermined analysis engine, delete a node in the graph data generated by the other analysis engine associated with the predetermined node.

6. The information processing device according to claim 1, wherein the predetermined analysis engine and the other analysis engine are analysis engines whose analysis contents are identical to each other.

7. A non-transitory computer-readable medium storing a program comprising instructions for causing an information processing device connected to a database storing graph data that are analysis results generated by analysis engines, respectively, and that have a data structure in which a plurality of nodes are connected, to realize:
a data processing unit for, based on a node information database which is set for each of the graph data compatible with the respective analysis engines and in which, with path information referring to a node in the respective graph data, identification information that is information for identifying the node referred to by the path information and that is identical for identical nodes is associated, executing a process of associating a node in the graph data having a predetermined data structure generated by a predetermined analysis engine and a node in the graph data generated by another analysis engine associated with identical identification information to the identification information associated with the node in the graph data having the predetermined data structure.

8. The non-transitory computer-readable medium storing the computer program according to claim 7, wherein the data processing unit is configured to apply information of a node in the graph data generated by the other analysis engine associated with a node in the graph data having the predetermined data structure generated by the predetermined analysis engine to the node in the graph data generated by the predetermined analysis engine, and convert the data structure of the graph data generated by the other analysis engine into the data structure of the graph data generated by the predetermined analysis engine.

9. An information processing method comprising:
by an information processing device connected to a database storing graph data that are analysis results generated by analysis engines, respectively, and that have a data structure in which a plurality of nodes are connected,
based on a node information database which is set for each of the graph data compatible with the respective analysis engines and in which, with path information referring to a node in the respective graph data, identification information that is information for identifying the node referred to by the path information and that is identical for identical nodes is associated, executing a process of associating a node in the graph data having a predetermined data structure generated by a predetermined analysis engine and a node in the graph data generated by another analysis engine associated with identical identification information to the identification information associated with the node in the graph data having the predetermined data structure.

10. The information processing method according to claim 9, comprising:
by the information processing device,
applying information of a node in the graph data generated by the other analysis engine associated with a node in the graph data having the predetermined data structure generated by the predetermined analysis engine to the node in the graph data generated by the predetermined analysis engine, and converting the data structure of the graph data generated by the other analysis engine into the data structure of the graph data generated by the predetermined analysis engine.
